(19) United States
(12) Patent Application Publication
(10) Pub. No.: US 2003/0004794 A1
(43) Pub. Date: Jan. 2, 2003

(54) Corporate rewards program overdraft method

(75) Inventor: Rick A. Hamilton II, Charlottesville, VA (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/892,965

(22) Filed: Jun. 27, 2001

(51) Int. Cl. G06F 17/60

(52) U.S. Cl. 705/14

(57) ABSTRACT

The invention provides a method, system and computer readable program code for providing awards to a customer including receiving an award request determining if the customer has a number of points to meet a predetermined number of points corresponding to the award request and authorizing a points overdraft if the customer has less than the predetermined number of points. The method may include a provision whereby the system determines if the customer has accrued a number of points equal or greater than the points overdraft after a predetermined time period has elapsed. If the customer has not accrued points to equal the overdraft, the system may impose a financial penalty on the customer.

### TECHNICAL FIELD OF THE INVENTION

The present invention relates generally to an award redemption program. More particularly, the present invention relates to a corporate rewards program that provides a user with a method to use awards or points, which have not been earned at the time of their use.

### BACKGROUND OF THE INVENTION

Today's consumers, and in particular, frequent business travelers well understand the proliferation of corporate rewards programs. The programs are designed to engender brand loyalty to hotels, airlines, and other businesses. The programs offer points of various kinds, such as frequent flyer miles, which can be earned by various purchases, and then redeemed for goods or services upon reaching certain predetermined or predefined plateaus. Such rewards as free flights, free hotel stays and reduced rate car rentals are commonly available after the accumulation of a prescribed amount or level of points, or the like.

One example of a frequency and award redemption program is illustrated by the travel industry to promote customer loyalty. Such programs are commonly known as a “frequent flyer” program. In such a program, when the customer books a flight, a certain amount of “mileage points” are awarded to the customer. In the travel industry the number of points earned is typically calculated by using a formula employing the distance traveled as a parameter. However, the points are not awarded until the traveler actually takes the flight and are not usable until after the points are accumulated at certain predefined levels.

When the customer has accumulated a sufficient number of points, those points may be redeemed for an award chosen from a specific list specified by the program. Thus, in the example given above of a frequent flyer program, a customer may redeem points earned for purchasing and taking flights for free flight tickets or a rental car etc. The customer generally needs to request a certificate, and use the issued certificate as payment for the free travel. While the rewarding of points may induce customer loyalty to an extent, there is an inherent amount of time between earning of the points and the ability of the customer to use the points. Also, during the time the customer has insufficient points to qualify for an award there is little incentive for the customer to continue using the company that issued the points.

Therefore, it would be desirable to achieve a strategy to permit customers to use awarded points or the like, in a manner that is most useful to the customer, while at the same time, providing motivation for the customer to remain loyal to the company that awarded the points.

### SUMMARY OF THE INVENTION

One aspect of the invention provides a method of providing awards to a customer including receiving an award request, determining if the customer has a number of points to meet a predetermined number of points corresponding to the award request and authorizing a points overdraft if the customer has less than the predetermined number of points.

Other aspects of a method of the invention may include determining if the customer has accrued a number of points equal to or greater than the points over draft after a predetermined time has elapsed. The time period may be at least 30 days. The time period may be about one, two or three months. The time period may be from about one day to about one year, or more. The method may include imposing a financial penalty on the customer if sufficient points have not accrued to meet the predetermined points level after the time period has elapsed. The financial penalty may include charging the customer for the price of the award. The financial penalty may include charging the customer interest on the price of the award. The authorization of the rewards overdraft may be based on customer criteria. Customer criteria may include authorization to debit a financial instrument such as, for example, a credit card, a debit card or a bank account. The customer criteria may include a determination with regard to a frequency of customer patronage of the company.

Another aspect of the invention provides a system of providing awards to a customer including means for receiving an award request, means for determining if the customer has a number of points to meet a predetermined number of points corresponding to the award request, and authorizing a points overdraft after a predetermined time period has elapsed.

Other aspects of the invention may further provide a system including means for determining if the customer has accrued a number of points equal to or greater than the point overdraft after a predetermined time period has elapsed. The time period may span from about one day to about one year. The system may further include a means for imposing a financial penalty on the customer is the customer has occurred less than the points over draft on expiration of the predetermined time period. The financial penalty may include charging the customer for the price of the award or charging the customer interest on the price of the award.

Another aspect of the invention provides a system including a computer readable medium including a program for providing awards to a customer including a computer readable program code for receiving an award request, computer readable program code for determining if the customer has a number of points to meet the predetermined number of points corresponding to the award request, and computer readable program code for authorizing a points overdraft if the customer has less than the predetermined number of points. The computer readable medium may further include computer readable program code for determining if the customer has accrued a number of points equal to or greater than the points over draft after a predetermined time period has elapsed. The system may further include computer readable program code for imposing a financial penalty on the customer if the customer has accrued less than the points overdraft on expiration of the predetermined time period.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of one embodiment of a system of the present invention for providing awards to a customer; and

FIG. 2 is a flow chart illustration one embodiment of a method of the present invention.

### DETAILED DESCRIPTION OF THE PRESENTLY PREFERRED EMBODIMENTS

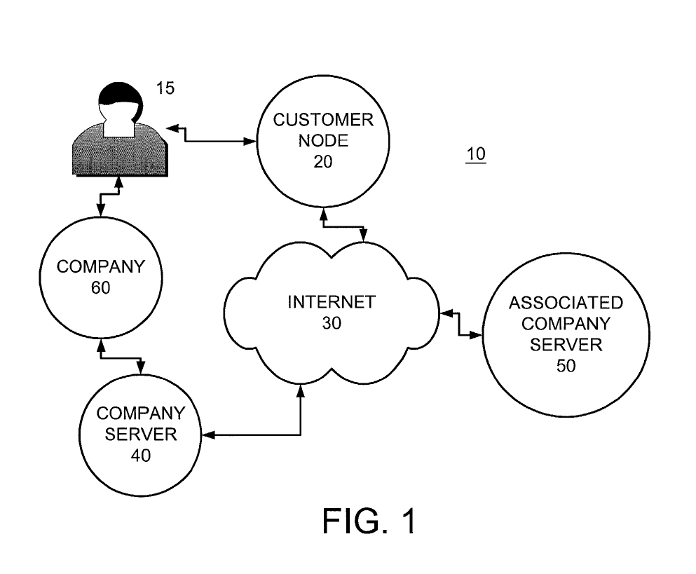

Referring to FIG. 1, one embodiment of the present invention for providing overdraft awards is shown in the aggregate as numeral 10. Generally, the present invention includes a method and system for providing customer awards before they are actually earned, essentially via a points overdraft or credit program. The customer is given a time period to earn the overdraft award points and meet a predetermined points level.

Turning to FIG. 1, a user of the system 10 can include a single customer or person 15, or other entity such as a corporate customer. The user 15 may earn reward points, or the like, by purchasing goods and/or services from company 60. The company 60, i.e., a first or primary company includes an entity that offers an awards program for use of its services or purchase of its goods. The user 15 can be in operative communication directly with the company 60 through direct means such as mail, telephone, wireless connection and so on. In one embodiment the user 15 is in communication with the company 60 through user node 20, Internet 30 and company server 40. The system 10 may also include an associate company server 50 in communication with primary company 60 and user 15 through Internet 30.

User node 20 may include a personal computer, personal digital assistant, wireless telephone, wireless personal information device or any device capable of communicating between user 15 and other elements of the system 10, for example, between user 15 and company 60 as known in the art. In one embodiment, the user node may be operably connected to the Internet 30. The Internet 30 may rout any number of digital signals to any of a plurality of server site addresses via various telecommunication means as is known.

Internet 30 may be connected to a company server 40. Company server 40 may be any computer server capable of routing digital signals to any other computer via the Internet 30, intranet, local area network or any other network using various telecommunications means known in the art to send and receive information. It will be understood that company server 40 may include a system and/or computer program including various database elements and processors to receive, store and process information related to the user 15 activity, purchases, awards provided and used. Company server 40 may be a server used by company 60 for receiving, storing and processing information related to the company 60 awards program. In the server 40 information related to the user 15 may be stored. The server 40 may include programs to receive, store and process information related to goods and/or services which the user 15 purchases from the company 60. The server 40 may include computer readable medium including a program that calculates an amount of reward earned by the user 15 for each transaction or purchase. The server 40 may include programs to sum, and store the total amount of rewards earned by each user 15 and determine if the user has enough award points to satisfy a predetermined plateau based on the request. The server 40 may include computer readable medium including a program for receiving and processing an award request from a user 15. The server 40 may include computer readable medium including a program for granting a points overdraft from a user 15. The overdraft request may include a request from a user 15 to debit the user reward or points account. The overdraft request may include a selection of a reward of a user 15, for example, a specific flight, or a specific good or service from the company 60. The server 40 may include a program for generating and tracking a time interval based on the date of the overdraft request. The server 40 may also include a program to determine and apply to the user account a penalty, payment or other disincentive, in the event the user 15 does not generate enough points to replenish the user awards point account or repay the overdraft in the specified or predetermined time interval.

It will be understood that the time interval for repayment or replenishing of the awards points, or the like, can be any time interval specified by the company. In one embodiment, the time interval can be 30 days. In other embodiments, the time interval can be one week or about one year.

It will be understood that the award may be in any suitable form, such as, for example, mileage, rental car privileges, goods, services, cash, vacations, and other awards.

User 15, through Internet 30, may also be connected to an associated company server 50. The associated company server 50 may be included to provide or share information regarding an award originating from the primary company 60 to a user 15, where the award is in the form of goods and/or services provided by the secondary or associated company 50. In other words, the user 15 may qualify for an award from, for example, an airline. The award may be in the form of “flyer miles” as is customary, which is provided by the airline. However, frequently, an airline may provide awards that are not in the form of air mileage but a related award such as use of a rental car or hotel room. In this case, the user 15 may qualify for an award and may use the reward to access and obtain use of a rental car or hotel from the secondary or associated company through server site 50.

It will be understood that the above example is illustrative and not restrictive in nature. Thus, the primary company 60 and secondary company 50, which may be a plurality of companies and which may or may not have cooperative agreements to offer and provide awards. Examples of companies that offer awards in the form of points, goods, services, cash and other incentives may include airlines, hotels, rental car agencies, video stores, ice cream stores, credit cards, banks, grocery stores, financial institutions, cruise and travel companies, automobile companies, telephone companies, music stores, and so on. The connection from user 15 to company system 40 and company system 50 may be an Internet connection or any suitable connection.

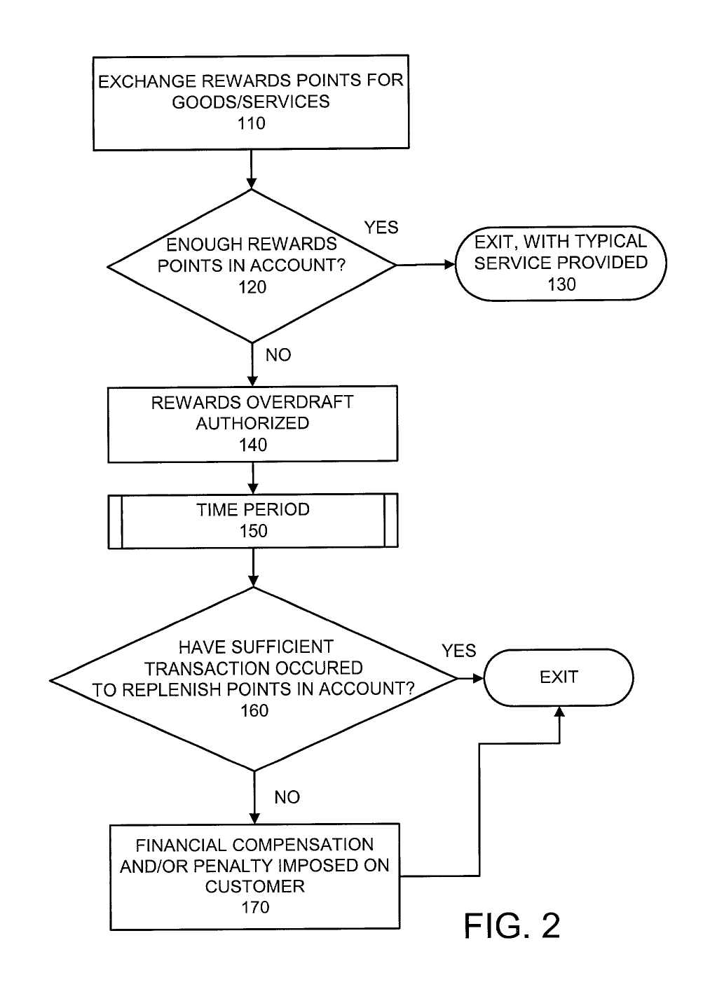

Turning to FIG. 2, one embodiment of a method for providing awards to a customer is illustrated. After a user 15 has made a purchase of goods and/or services from a company 60, awards points may be generated. The points may be stored in a company computer or server 40 or any suitable system.

At some point, the user 15 may present the company 60 with a request to exchange rewards points for goods and/or services (Block 110). It will be understood that the rewards may or may not be related to company goods and/or services. In one embodiment, the awards are goods and/or services provided by a secondary or associated company.

After the request is received, a determination may be made whether there are enough points in the account to provide the award to the user 15 (Block 120). In the event that there are enough points to provide the award to the customer or user 15, the award is provided in the conventional fashion and the account debited accordingly (Block 130).

In the event that there are not enough points in the account of the user 15, a process is initiated to authorize an overdraft of the account (Block 140). The process of authorizing an overdraft of the user account may include accessing a database or otherwise determining at least one of a set of customer criteria. The company may use the customer criteria to determine whether or not to authorize the rewards overdraft. The customer criteria may include but is not limited to an authorization to debit a financial instrument such as, for example, a customer credit or debit card, access to a customer bank account, the frequency which the customer patronizes the company 60, historical repayments or replenishing of award point overdrafts and the like.

The process may include determining whether the user has provided a credit or debit card or access to other financial instruments or accounts, for example, a savings or checking account and an authorization to debit the instrument or bank account in the event that the user cannot timely fulfill the terms of an overdraft portion of the company awards agreement, i.e., purchase enough goods and/or services to replenish the account award points. It will be understood that other suitable checks may be included in the authorization process to determine whether the user 15 may qualify for the overdraft to the user account, for example, a credit check of the user or customer 15.

After the overdraft authorization has been approved or granted, a predetermined time period may be provided for the user 15 to replenish the awards account (Block 150). The time period may be any suitable time period. In one embodiment, the time period may be 30 days. In other embodiments, the time period may be one, two, three or more months. In the predetermined time period the user 15 may earn enough points or the like to meet or exceed the overdraft or debit of the awards account.

After the predetermined time period has expired, in one embodiment, the company server 40 makes a determination, whether the user 15 has made sufficient purchases of goods and/or services to earn points and replenish the user account (Block 160). In the event that the user 15 has earned sufficient points in the predetermined time period to replenish the user account no penalty is accessed. In one embodiment, the notification of the debt repayment may be sent to the consumer 15 when such replenishment is accomplished. The notification may be in e-mail form, a telephone call, a mailing or any suitable notification.

In the event that the user 15 has not replenished the points in the user account, a financial penalty is imposed on the user 15 (Block 170). The penalty may be in the form of a monetary debit to the user credit or debit card or bank account, for example. The amount of the penalty may be the full or discounted price of the awarded goods and/or services. The penalty may be the imposition of an interest charge against the full or reduced price of the awarded goods and/or services. Other suitable financial compensation is contemplated as being assessed against the user 15 in the event that award points are not earned by the termination of the time period. In this manner, the user 15 is encouraged to continue earning awards points by purchasing goods and services from the primary company 60.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of providing awards to a customer comprising:
receiving an award request;
determining if the customer has a number of points to meet a predetermined number of points corresponding to the award request; and
authorizing a points overdraft if the customer has less than the predetermined number of points.

2. The method of claim 1 further comprising:
determining if the customer has accrued a number of points equal or greater than the points overdraft after a predetermined time period has elapsed.

3. The method of claim 2 wherein the time period is a range of about one day to about one year.

4. The method of claim 2 further comprising:
imposing a financial penalty on the customer if the customer has accrued less than the points overdraft on expiration of the predetermined time period.

5. The method of claim 4 wherein the financial penalty includes charging the customer for the price of the award.

6. The method of claim 4 wherein the financial penalty includes charging the customer interest based on the price of the award.

7. The method of claim 4 wherein the authorization of the rewards overdraft is based on customer criteria.

8. The method of claim 7 wherein the customer criteria includes a customer authorization to debit a financial instrument.

9. The method of claim 7 wherein the customer criteria includes a frequency of customer patronage.

10. A system of providing awards to a customer comprising:
means for receiving an award request;
means for determining if the customer has a number of points to meet a predetermined number of points corresponding to the award request; and
means for authorizing a points overdraft if the customer has less than the predetermined number of points.

11. The system of claim 10 further comprising:
means for determining if the customer has accrued a number of points equal to or greater than the points overdraft after a predetermined time period has elapsed.

12. The system of claim 11 wherein the time period is a range of about one day to about one year.

13. The system of claim 12 further comprising:
means for imposing a financial penalty on the customer if the customer has accrued less than the points overdraft on expiration of the predetermined time period.

14. The system of claim 13 wherein the financial penalty includes charging the customer for the price of the award.

15. The system of claim 13 wherein the financial penalty includes charging the customer interest based on the price of the award.

16. The system of claim 10 wherein the authorization of the rewards overdraft is based on customer criteria.

17. The system of claim 16 wherein the customer criteria includes a customer authorization to debit a financial instrument.

18. The system of claim 16 wherein the customer criteria includes a frequency of customer patronage.

19. A computer readable medium including a program for providing awards to a customer comprising:
computer readable program code for receiving an award request;
computer readable program code for determining if the customer has a number of points to meet a predetermined number of points corresponding to the award request; and
computer readable program code for authorizing a points overdraft if the customer has less than the predetermined number of points.

20. The computer readable medium of claim 19 further comprising:
computer readable program code for determining if the customer has accrued a number of points equal to or greater than the points overdraft after a predetermined time period has elapsed.

21. The system of claim 19 further comprising:
computer readable program code for imposing a financial penalty on the customer if the customer has accrued less than the points over draft on the expiration of the predetermined time period.
